(19) United States
(12) Patent Application Publication
(10) Pub. No.: US 2021/0366043 A1
(43) Pub. Date: Nov. 25, 2021

(54) SYSTEM AND METHOD FOR EXCHANGING CURRENCY

(71) Applicant: Young Jin Choi, Lima (PE)

(72) Inventor: Young Jin Choi, Lima (PE)

(21) Appl. No.: 16/878,123

(22) Filed: May 19, 2020

(51) Int. Cl. G06Q 40/04; G06Q 20/38

(52) U.S. Cl. CPC G06Q 40/04; G06Q 20/381

(57) ABSTRACT

A method for exchanging currency at an online currency exchange platform is provided that includes receiving a first request from a first client device of a seller to exchange a first type of currency amount with a second type or currency amount calculated at a currency exchange rate; communicating the first request to a second client device of a buyer; receiving a response by the second client device to accept the first request; receiving the first type of currency amount from a first account associated with the first client device; receiving the second type of currency amount from a second account associated with the second client device; and transferring the first type of currency amount to a third account associated with the second client device and the second type of currency amount to a fourth account associated with the first client device.

### FIELD

This application relates to an online system and method for exchanging currency.

### BACKGROUND

Online currency exchange is an online system for exchanging one country's currency for another, whether it be at a governmental level (between countries) or at a business level (seller and buyer) in a secure, centralized setting. An online currency exchange affords immediate transparency, which allows the respective parties to keep tabs on all aspects of the transaction, thereby increasing efficiency, lowering costs, and enhancing security. However, there is often a commission on currency exchanges between buyers and sellers due to the intervention of a bank or money exchanger. It would be desirable to provide an online system and method for exchanging currency that is an improvement over the known system.

### SUMMARY

In one aspect of the present invention, a computer-implemented method for exchanging currency is provided. The method includes receiving, at an online currency exchange platform, a first request from a first client device of a seller to exchange a first amount of a first type of currency with a second amount of a second type of currency calculated at a currency exchange rate; communicating the first request to at least a second client device of a buyer; receiving, at the online currency exchange platform, a response by the second client device to accept the first request from the first client device; receiving, at the online currency exchange platform, the first amount of the first type of currency from a first account of the first type of currency associated with the first client device; receiving, at the online currency exchange platform, the second amount of the second type of currency from a second account of the second type of currency associated with the second client device; and transferring the first amount of the first type of currency to a third account of the first type of currency associated with the second client device and the second amount of the second type of currency to a fourth account of the second type of currency associated with the first client device.

In another aspect of the present invention, a non-transitory computer-readable storage medium is provided. The non-transitory computer-readable storage medium stores executable instructions that, as a result of being executed by one or more processors of a computer system, cause the computer system to at least receive, at an online currency exchange platform, a first request from a first client device of a seller to exchange a first amount of a first type of currency with a second amount of a second type of currency calculated at a currency exchange rate; communicate the first request to at least a second client device of a buyer; receive, at the online currency exchange platform, a response by the second client device to accept the first request from the first client device; receive, at the online currency exchange platform, the first amount of the first type of currency from a first account of the first type of currency associated with the first client device; receive, at the online currency exchange platform, the second amount of the second type of currency from a second account of the second type of currency associated with the second client device; and transfer the first amount of the first type of currency to a third account of the first type of currency associated with the second client device and the second amount of the second type of currency to a fourth account of the second type of currency associated with the first client device.

### BRIEF DESCRIPTION OF THE DRAWINGS

FIG. 1 is a block diagram illustrating the general architecture of a client-server application system that operates in accordance with embodiments of the present invention;

FIG. 2 is a flow diagram of a method of the system FIG. 1 according to a first embodiment of the present invention;

FIG. 3 is a schematic front view of mobile device displaying a currency exchange offer message by a seller and an accept button on the display of the mobile device of the system according to method of FIG. 2;

FIG. 4 is a flow diagram of a method of the system of FIG. 1 according to a second embodiment of the present invention;

FIG. 5 is a schematic front view of mobile device displaying a currency exchange offer message by a seller and a deal button on the display of the mobile device of the system according to the method of FIG. 4;

FIG. 6 is a schematic front view of mobile device displaying a currency exchange counteroffer message by a buyer and an accept button on the display of the mobile device of the system according to method of FIG. 4;

FIG. 7 is a schematic front view of mobile device displaying a currency exchange offer message with the original terms changed by a seller and an accept button on the display of the mobile device of the system according to the method of FIG. 4; and

FIG. 8 is a block diagram illustrating the exchange platform in operative connection with the client devices.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

As used herein, the term “module” may refer to a hardware based module, software based module or a module may be a combination of hardware and software resources. A module (whether hardware, software, or a combination thereof) may be designed to implement or execute one or more particular functions, tasks or routines of the system. Embodiments of hardware based modules may include self-contained components such as chipsets, specialized circuitry and one or more memory devices. A software-based module may be part of a program code or linked to program code containing specific programmed instructions loaded in a memory device.

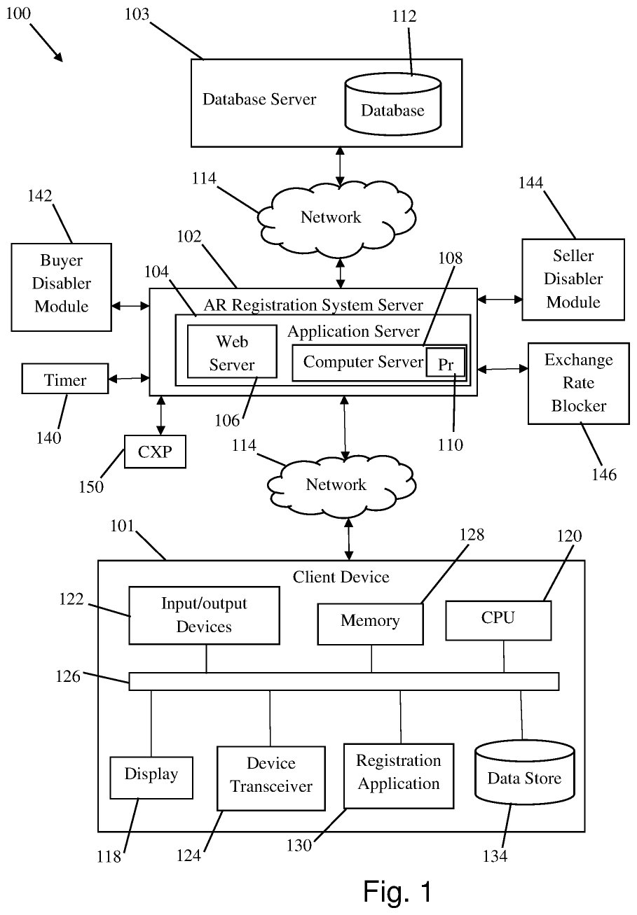

FIG. 1 illustrates the general architecture of a client-server application system 100 that operates in accordance with embodiments of the present invention. In a preferred embodiment, system 100 is implemented in multi-tier or n-tier architecture with one or more client devices 101 residing at the client tier, one or more servers 102 in the middle or server application tier and one or more database servers 103 residing in the database tier. In the above variant of three-tier architecture the client, the first tier, may have to only perform the user interface i.e., validate inputs; in which case the middle tier holds all the backend logic and does data processing while the data server, the third tier, performs data validation and controls the database access.

One or more client devices 101 are connected to system server 102 via a network 114. The system server 102 communicates with the client devices 101 over the network 114 to present a user interface or graphical user interface (GUI) for the service system 100 of the present invention. The online currency exchange platform 150 is in operative connection with the system server and other components of the system 100. The user interface of the service system 100 of the present invention can be presented through a web browser or through a mobile application communicating with the system server 102 and is used for displaying, entering, publishing, and/or managing data required for the service. As used herein, the term “network” generally refers to any collection of distinct networks working together to appear as a single network to a user. The term also refers to the so-called world wide “network of networks” or Internet which is connected to each other using the Internet protocol (IP) and other similar protocols. As described herein, the exemplary public network 114 of FIG. 1 is for descriptive purposes only and it may be wired or wireless. Although the description may refer to terms commonly used in describing public networks such as the Internet, the description and concepts equally apply to other public and private computer networks, including systems having architectures dissimilar to that shown in FIG. 1. The inventive idea of the present invention is applicable for all existing cellular network topologies or respective communication standards, such as GSM, UMTS/HSPA, LTE and the like.

With respect to the present description, the system server 102 may include any service that relies on a database system that is accessible over a network, in which various elements of hardware and software of the database system may be shared by one or more users of the system 100. To this end, the users of the client device 101, from which a request or instruction is received over a network 114, may include any individual customer, a governmental or non-governmental organization, a group etc. The GUI or user interface provided by the system server 102 on the client devices 101 through a web browser or mobile app may be utilized by the users for utilizing service system 100. The client device 101 is used by both buyers and sellers utilizing the present invention, and can be embodied, for example, in a smartphone.

The components appearing in system server 102 refer to an exemplary combination of those components that would need to be assembled to create the infrastructure to provide the tools and services contemplated by the present invention. As will be apparent to one skilled in the relevant art(s), all of components “inside” of system server 102 may be connected and may communicate via a wide or local area network (WAN or LAN).

The system server 102 includes an application server or executing unit 104. The application server or executing unit 104 comprises a web server 106 and a computer server 108 that serves as the application layer of the present invention. The Web server 106 is a system that sends out Web pages containing electronic data files in response to Hypertext Transfer Protocol (HTTP) requests from remote browsers (i.e. browsers installed in the client devices 101) or in response to similar requests made through a mobile app or mobile application of the present invention installed on a client device 101. The web server 106 can communicate with the mobile app of the present invention and/or with a web browser installed on a client device 101 to provide the user interface required for the service.

The computer server 108 may include a processor 110, a random-access memory (RAM) (not shown in figures) for temporary storage of information, and a read only memory (ROM) (not shown in figures) for permanent storage of information. Computer server 108 may be generally controlled and coordinated by operating system software. The operating system controls allocation of system resources and performs tasks such as processing, scheduling, memory management, networking, and I/O services, among (other) things. Thus, the operating system resides in system memory and, on being executed by CPU, coordinates the operation of the other elements of AR server 102.

Although the description of the computer server 108 may refer to terms commonly used in describing computer servers, the description and concepts equally apply to other processing systems, including systems having architectures dissimilar to that shown in FIG. 1.

The database tier is the source of data where at least one database server 103 generally interfaces multiple databases 112. Those databases are frequently updated by their users and administrators most often through a combination of private and public networks 114 including the Internet. It would be obvious to any person skilled in the art that, although described herein as the data being stored in a single database, different separate databases can also store the various data and files of multiple users.

A mobile application, or “app,” is a computer program that may be downloaded and installed in client device 101 using methods known in the art. Hereinafter, the mobile app 130 is referred to as app 130. App 130, custom built for the present invention, enables one or more persons to do various tasks related to live, in-person translation services using the system of the present invention. The activities related to the service of the present invention can also be performed using the user interface (or GUI) presented through a client device-based web browser. Hereinafter, the term “user interface” is used to refer to both app user interface and the web browser user interface of the present invention. Examples of client device 101 may include, but not limited to, mobile devices, tablets, hand-held or laptop devices, smart phones, personal digital assistants, desktop computers, wearable devices, augmented reality glasses, virtual reality headsets, or any similar device.

As illustrated in FIG. 1, the client device 101 may include various electronic components known in the art for this type of device. In this embodiment, the client device 101 may include a device display 118, a computer processor 120, user input/output devices 122 (examples of input devices may be a touch screen, keyboard, microphone, and/or other form of input device known in the art), a device transceiver 124 for communication, a device memory 128, the AR app 130 operably installed in the computer memory 128, a local data store 134 also installed in the device memory 128, and a data bus 126 interconnecting the aforementioned components. For purposes of this application, the term “transceiver” is defined to include any form of transmitter and/or receiver known in the art, for cellular, WIFI, radio, and/or other form of wireless or wired communication known in the art. Obviously, these elements may vary, or may include alternatives known in the art, and such alternative embodiments should be considered within the scope of the claimed invention.

The system includes a timer 140 that tracks the time during certain conditions. For example, the timer 140 tracks the time during activation of the reserve status condition. The reserve status condition is activated for a preset period of time. The system also includes a buyer disabler module 142. The buyer disabler module 142 is in operative connection with the server 102. When the buyer disable module 142 is activated, the buyer disabler module 142 disables other buyers from clicking on the seller's list to accept an offer. The system also includes a seller disabler module 144. The seller disabler module 144 is in operative connection with the server 102. When the seller disable module 144 is activated, the seller disabler module 144 prevents the seller from revoking his or her listing if the seller decides to do so.

The system also includes an exchange rate blocker 146. The exchange rate blocker 146 may be hardware based, software based or a combination of hardware and software resources. The exchange rate blocker 146 (whether hardware, software, or a combination thereof) may be designed to implement or execute one or more particular functions, tasks or routines of the system. Embodiments of hardware based exchange rate blockers 146 may include self-contained components such as chipsets, specialized circuitry and one or more memory devices. A software-based exchange rate blocker 146 may be part of a program code or linked to program code containing specific programmed instructions loaded in a memory device. The exchange rate blocker 146 is in operative connection with the server 102. When the exchange rate blocker 146 is activated, the seller cannot change his or her exchange rate listed on the exchange offer.

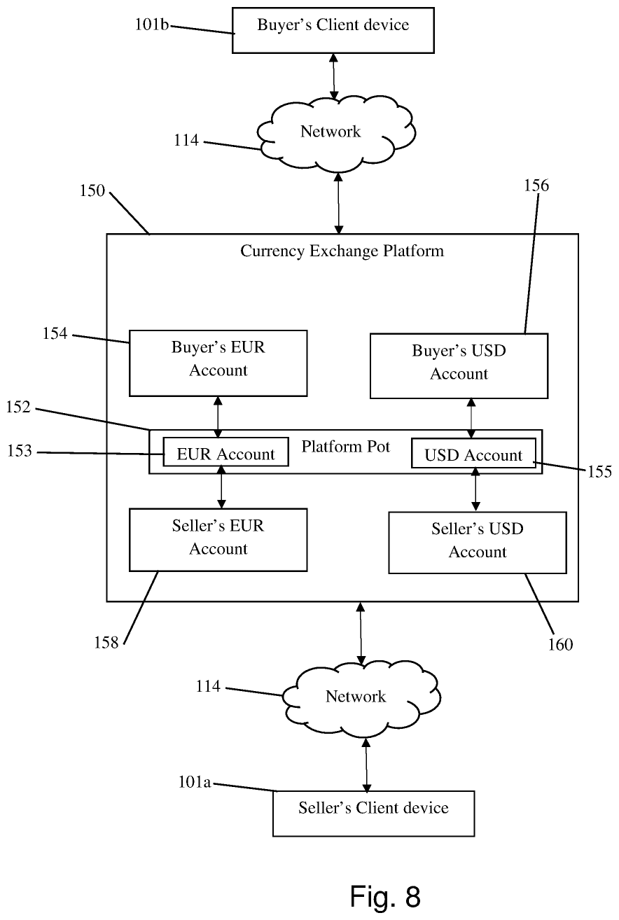

FIG. 8 is a block diagram illustrating the online currency exchange platform 150 in operative connection via the network 114 with a seller client device 101a and a buyer client device 101b. In this exemplary embodiment, the currency exchange platform 150 includes an electronic platform pot 152, a buyer's EUR account 154, a buyer's USD account 156, a seller's EUR account 158 and a seller's USD account 160. In this example, the platform pot 152 includes a EUR account 153 and a USD account 155. The accounts are electronic accounts. Currency from the seller and buyer currency accounts can be transferred to the currency accounts of the platform pot 150 and transferred back to the seller and buyer currency accounts from the currency accounts of the platform pot 152 by commands from the client devices 101a, 101b as explained in further detail below. The platform pot 152 may include more different types of currency accounts (e.g. Mark, Yen, Peso, Yuan, etc.) and there can be more sellers and buyers with more than two different types of currency accounts. Alternatively, the buyer's and seller's currency accounts may be located outside of the currency exchange platform 150.

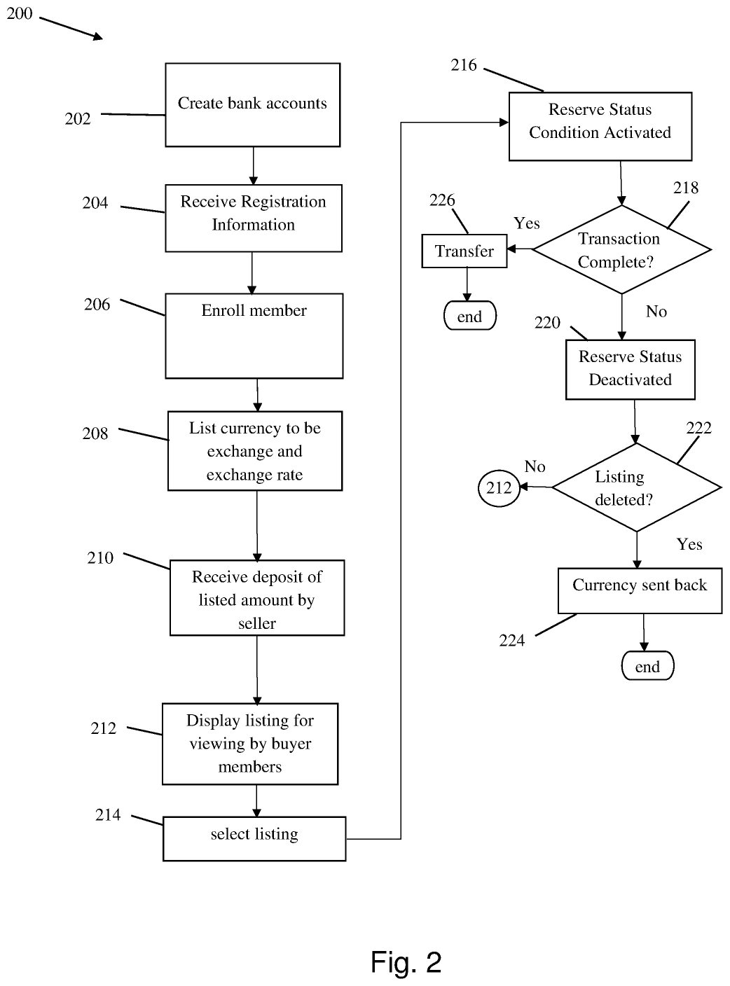

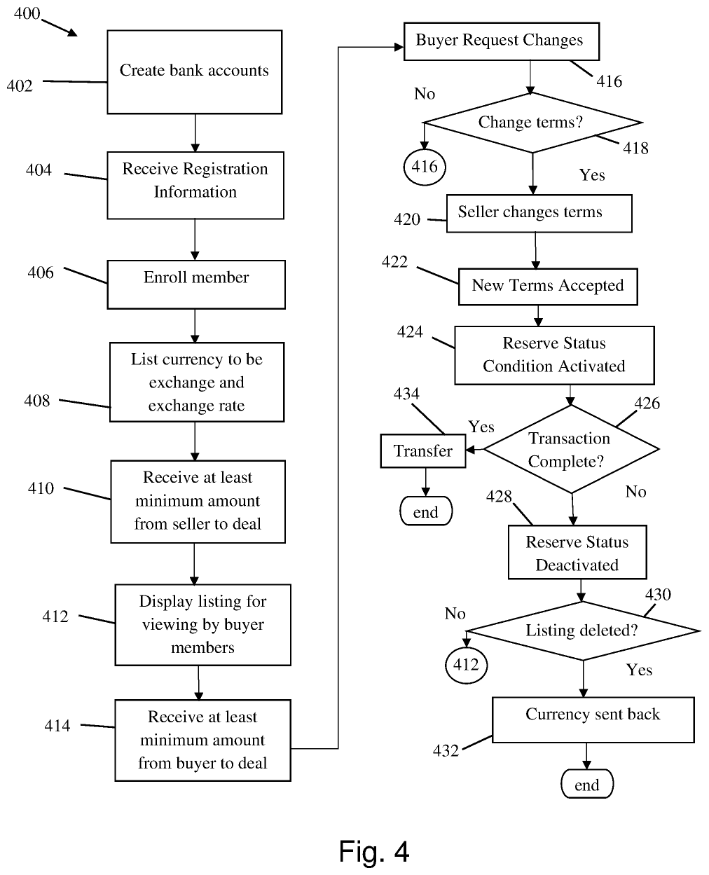

With reference now to FIGS. 2 and 4, example methodologies are illustrated and described. While each methodology is described as being a series of acts or steps that are performed in a sequence, it is to be understood that each methodology is not limited by the order of the sequence. For instance, some acts or steps may occur in a different order than what is described herein. In addition, a step may occur concurrently with another step. Furthermore, in some instances, not all steps may be required to implement a methodology described herein.

Moreover, the steps or acts described herein may be computer-executable instructions that can be implemented by the processor 120 or one or more processors and/or stored in the memory 128 and/or on a computer-readable medium or media. The computer-executable instructions may include a routine, a sub-routine, programs, a thread of execution, and/or the like. Still further, results of acts of the methodology may be stored in a computer-readable medium, displayed on a display device, and/or the like. The computer-readable storage medium may be non-transitory.

FIG. 2 shows a method 200 comprising operative sequence of steps in which a buyer exchanges currency with a seller online as members of the online currency exchange platform according to a first embodiment. The currency exchange platform 150 holds at least one national currency bank account and one foreign currency bank account of its own that is referred to as the platform pot 152. For example, the platform pot 152 may include a EUR account 153 and a USD account 155. In step 202, a potential member creates at least two bank accounts with different types of currency in the currency exchange platform 150. For example, the potential member may create one bank account that is in the national currency of the potential member and another bank account that is in a foreign currency from the national currency of the potential member. Once a potential member has the national currency bank account and the foreign currency bank account he or she can register as a member by providing information in an online form on the online currency exchange platform 150 that is received by the registration application 130 in step 204. In this step, the form from the registration application 130 will prompt the potential member to set a User ID and password. Then, the form will prompt the potential member to provide personal data that includes the email address of the potential member and the national currency bank account number and foreign currency bank account number of the potential member.

Then, in step 206, the registration application 130 will enroll the potential member to be a member of the online currency exchange platform 150. The member may be a selling member and/or buying member. Then, in step 208, the selling member (“seller”) lists his or her currency that he or she wants to exchange on the public board of the online currency exchange platform 150 and the exchange rate that the seller wants to apply. The currency that the member lists may be his or her national currency or foreign currency. The system may require a minimum and/or maximum amount listed that is to be exchange. In step 210, the seller sends (deposits) the listing amount of that currency from the seller's currency account into the platform pot 152.

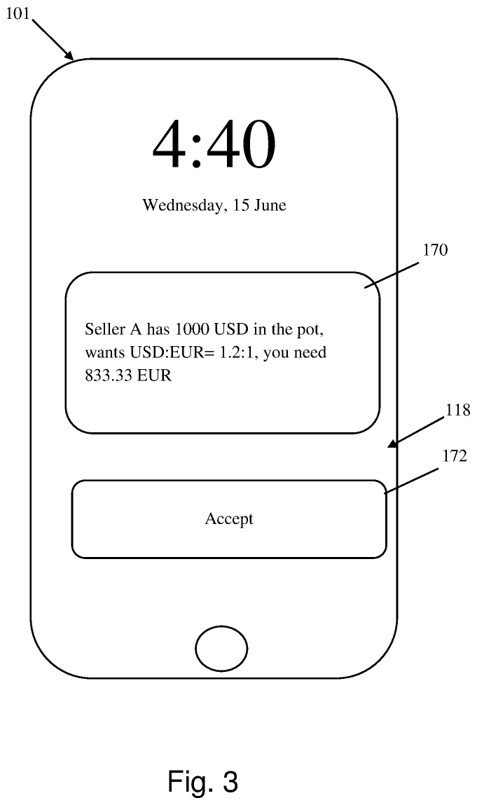

After the listing amount currency has been received and cleared into the currency account of the platform pot 152 that corresponds to the currency of the listing amount, then in step 212, the listing becomes visible on a public board to communicate to other members to see on their display 118 of their client devices 101. Each listing on the public board will show a request by the seller as a message 170 comprising the user ID, the currency type (national currency or foreign currency), the amount (held in the platform pot), the currency exchange rate the seller wants to apply and corresponding opposite currency amount that buying member needs to have. For example, FIG. 3 illustrates a schematic front view of mobile device 101b displaying a currency exchange offer message 170 requested by a seller and an accept button 172 on the display 118 of the mobile device 101b of the system 100. In step 214, a buying member (“buyer”) checks the public board and selects their desired listing by clicking the accept button 172 to activate the reserve status condition via activation of the buyer disabler module 142 and start tracking the time by the timer 140.

In step 216, the reserve status condition is activated for the preset period of time. In the reserve status condition, the buyer disabler module 142 is activated for the preset period of time after the reserve status condition is activated to block or prevent the online currency exchange platform 150 from receiving responses from other buyers to accept the request by the seller of the offer to exchange currency so as to allow the buyer to complete the transaction without interruption. In one example, the buyer disable module 142 disables the activation of the accept button 172 by the other buyers to accept the seller's offer, so that the buyers cannot click on the accept button 172 for that listing for a preset period of time after the reserve status condition is activated. In the reserve status condition, the system 100 also activates the exchange rate blocker 146 so that the seller cannot change his exchange rate. Also, in the reserve status condition in which the buyer is doing the transaction, the seller disabler module 144 is activated to prevent the seller from revoking his or her listing if the seller tries to do so. In the reserve status condition, the buyer can complete the transaction by depositing the currency amount as listed by the seller from the buyers currency account into the platform pot 152, which goes to the currency account of the type that corresponds to the type of currency that the buyer deposited.

In step 218, a query is made by the system 100 to determine if the transaction is completed or not within the preset period of time after the online currency exchange platform 150 receives the response by the buyer to accept the seller's listing to activate the reserve status condition. If the transaction is not complete within the preset period of time after the reserve status condition is activated, then the system 100 turns off or deactivates the buyer disabler module 142 to deactivate the reserve status condition in step 220, so that the listing becomes available back to the buying members. The system 100 may also turn off or deactivate the seller disabler module 142 in this step so that the seller may revoke or remove his or her listing if the seller decides to do so. The exchange rate blocker 146 may also be turned off or deactivated by the system 100 in this step so that the seller can change his or her exchange rate for that listing. In step 222, a query is made to determine whether the seller deleted the listing. If the seller deleted the listing, the currency in the listing will be sent back to the seller's currency account where it came from in step 224. Then, the method ends. If the seller did not delete the listing, the method goes back to step 212.

If the system 100 determines that the transaction is completed within the preset period of time after the online currency exchange platform 150 receives the response by the buyer to accept the seller's listing to activate the reserve status condition, then the system 100 sends out or transfers the exchanged amounts into the corresponding currency accounts of the seller and buyer in step 226. Then, the method ends. The system 100 will allow the seller to revoke his or her listing if he or she decides to, but only if the listing is not engaged into changed status where a buying member could be on the transaction process. If the revoking is allowed, the system 100 will delete the listing and send his or her currency back to the account. Once a buyer chooses a listing by clicking on it, he should send the correct amount into the platform pot 152 within the time allowed. Once the buyer's deposit is cleared to the platform pot 152, the system 100 sends out or transfers the exchanged amount into each member's corresponding currency account.

For example, with reference to FIG. 3, Seller A wants to change his 1000 US Dollar (USD) into Euro (EUR) at the rate of USD to EUR to be 1.2:1. So, there needs to be an account having 833.33 Euro for Seller A. Seller A deposits 1000 USD from the Seller A's USD account 160 into the USD account 155 of the platform pot 152. Seller A then lists on the display the following information “Seller A has 1000 USD in the pot, wants USD:EUR=1.2:1, you need 833.33 EUR”. This information is listed for the potential buyers to see and accept the exchange transaction. Buyer B views the display 118, sees Seller A listing information and decides to accept the exchange transaction. Buyer B clicks on the accept button 172 of that listing, which also actives the reserve condition status. Buyer B deposits 833.33 EUR from the Buyer B's EUR account 154 into the EUR account 153 of the Platform pot 152 before the preset period of time after the reserve condition status is activated. The system realizes the correct amount from the Seller A and Buyer B are in the platform pot 152. The system then deposits 833.33 EUR from the EUR account of the platform pot 152 into Seller A's Euro account 158 and 1000 USD from the USD account of the platform pot 152 into Buyer B's US Dollar account 156.

FIG. 4 shows a method 400 comprising an operative sequence of steps in which a buyer exchanges currency with a seller online as members of the online currency exchange platform 150 according to a second embodiment. Like the first embodiment, the platform holds at least one national currency bank account and one foreign currency bank account of its own that will be referred to as platform pot 152. For example, the platform pot 152 may include the EUR account 153 and the USD account 155. In this second embodiment, the platform pot 152 may have lists of approximate amounts with the desired exchange rate but not yet in the platform pot 152. The method 400 starts with a potential member creating at least two bank accounts with different types of currency in the currency exchange platform 150 in step 402. For example, the potential member may create one bank account that is in the national currency of the potential member and another bank account that is in a foreign currency from the national currency of the potential member. Once a potential member has the national currency bank account and the foreign currency bank account he or she can register as a member by providing information in an online form on the online currency exchange platform 150 that is received by the registration application in step 404. In this step, the form from the registration application will prompt the potential member to set a User ID and password. Then, the form will prompt the potential member to provide personal data that includes the email address of the potential member and the national currency bank account number and foreign currency bank account number of the potential member.

Then, in step 406, the registration application will enroll the potential member to be a member of the online currency exchange platform 150. The member may be a selling member and/or buying member. Then, in step 408, the selling member (“seller”) lists his or her amount of currency that he or she wants to exchange on the public board of the online currency exchange platform 150 and the currency exchange rate that the seller wants to apply. The currency that the member lists may be his or her national currency or foreign currency. The system may require a minimum and/or maximum amount listed that is to be exchange. In this second embodiment, the selling member sends (deposits) at least a minimum portion of the currency of the listing amount into the corresponding currency account of the platform pot 152 as required by the system for dealing and to enable the listing of the currency amount to be exchanged by a buyer in step 410. The listing amount in the second embodiment is considered trustable because the seller has placed a small portion of the amount to exchange in the platform pot 152 as guarantee money to appear on the list. So, for example, the system 100 may require a minimum amount of guarantee money listed for dealing and to enable the seller to list money to be exchanged by a buyer. The system 100 may also require a minimum portion of the amount for the buyer to deposit to accept the offer listed by the seller or to be able to have the right to deal with the seller to exchange the currency. This minimum portion of the amount may also be required by the buyer to deposit to accept any other offer listed by any seller. In one example, the offer might be an option contract.

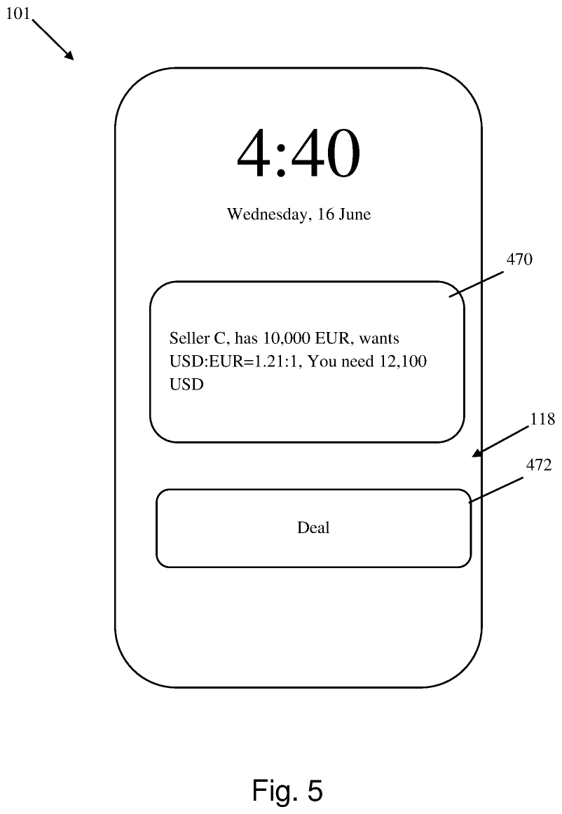

After the at least minimum amount has been received and cleared into the corresponding currency account of the platform pot 152, then in step 412, the listing becomes visible on a public board to communicate to other members to see on their display 118 of their client devices 101. Each listing on public board will show a request by the seller as a message 470 comprising the user ID, the currency type (national currency or foreign currency), the amount for exchanging, the currency exchange rate the seller wants to apply and corresponding opposite currency amount that buying member needs to have, and a deal button 472 as show for example in FIG. 5. In step 414, a buying member checks the public board and sends at least the minimum portion of the amount of the currency that the seller wants to the corresponding currency account of the platform pot 152 to obtain the right to deal with the seller. The buyer may send the at least minimum portion of the currency of the type desired by the seller in the corresponding currency account of the platform pot 152 and click the deal button 472 to obtain the right to deal. Alternatively, the buyer may just send the at least minimum portion of the currency of the type desired by the seller in the corresponding currency account of the platform pot 152 to obtain the right to deal.

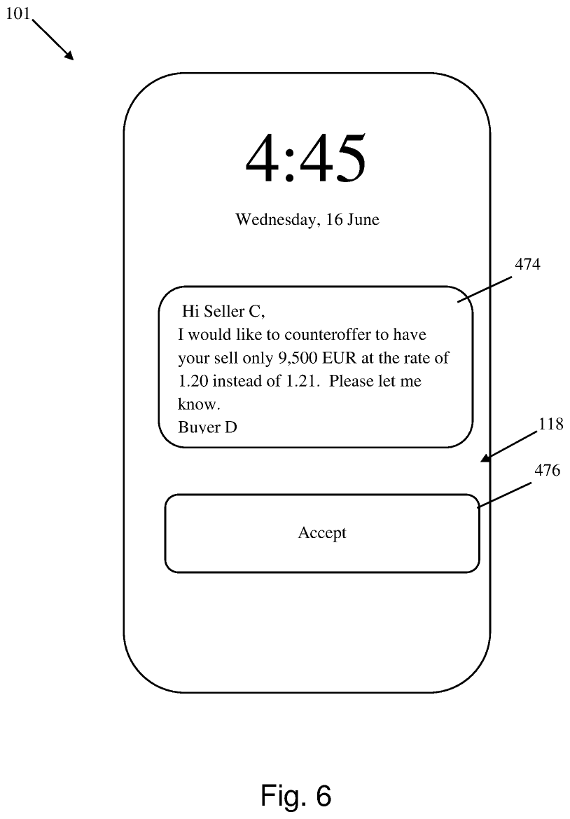

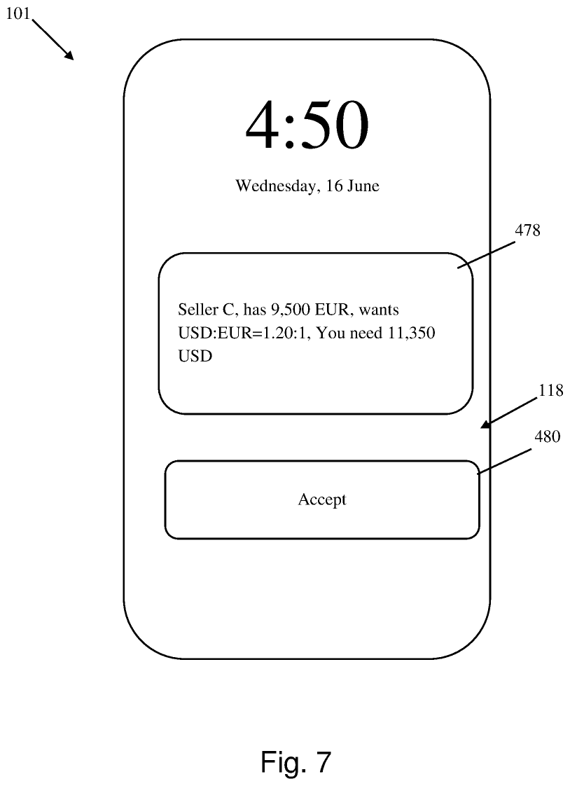

Then, after the system 100 receives that amount, the online currency exchange platform 150 may receive a response by the buyer to communicate to the seller a counteroffer with new terms, in step 416, by displaying a message 474 on the display 118 asking if the seller could change the amount the seller listed to exchange and/or the exchange rate as shown for example in FIG. 6. The seller can accept or deny the counteroffer to change the seller's amount and/or the exchange rate in step 418. If the seller denies the counteroffer, then the method goes back to step 416. If the seller accepts the counteroffer to change the seller's amount and/or the exchange rate, the online currency exchange platform receives the changes to the amount and/or the rate on the listing by the seller in step 420. The seller can accept the counteroffer by clicking on the accept button 476 and then change the amount and/or rate. Alternatively, the seller can accept the counteroffer by just changing the amount and/or rate. Alternatively, the seller can propose new terms. Seeing this change displayed in the private window and shown as a message 478 (FIG. 7) on the display 118, the buyer accepts the new terms by clicking on an accept button 480 inside the private chatting window in step 422. Also, in step 422, the seller accepts the change by clicking on an accept button 480. In step 424, the reserve status condition is activated after step 422 via the buyer disabler module for a predetermined period of time in a similar manner as previously mentioned for the method of the first embodiment. In the reserve status condition, the system 100 also activates the exchange rate blocker 146 so that the seller cannot change his exchange rate. Also, in the reserve status condition in which the buyer is doing the transaction, the seller disabler module 144 is activated to prevent the seller from revoking his or her listing if the seller tries to do so. In this second embodiment, the seller and buyer can deposit amounts so that the total amount that each has deposited is the amount that they agreed to complete the transaction.

In step 426, a query is made by the system 100 to determine if the transaction is completed or not within the preset period of time after the online currency exchange platform 150 receives the response by the buyer to accept the seller's listing with the changed terms to activate the reserve status condition. If the transaction is not complete within the preset period of time after the reserve status condition is activated, then the system 100 turns off or deactivates the buyer disabler module 142 to deactivate the reserve status condition in step 428, so that the listing becomes available back to the buying members. The system 100 may also turn off or deactivate the seller disabler module 142 in this step so that the seller may revoke or remove his or her listing if the seller decides to do so. The exchange rate blocker 146 may also be turned off or deactivated by the system 100 in this step so that the seller can change his or her exchange rate for that listing. In step 430, a query is made to determine whether the seller deleted the listing. If the seller deleted the listing, the currency in the listing will be sent back to the seller's currency account where it came from in step 432. Then, the method ends. If the seller did not delete the listing, the method goes back to step 412.

If the system 100 determines that the transaction is completed within the preset period of time after the online currency exchange platform 150 receives the response by the buyer to accept the seller's listing to activate the reserve status condition, then the system 100 sends out or transfers the exchanged amount into the corresponding currency accounts of the seller and buyer in step 434. Then, the method ends. The system 100 will allow the seller to revoke his or her listing if he or she decides to, but only if the listing is not engaged into changed status where a buying member could be on the transaction process. If the revoking is allowed, the system 100 will delete the listing and send his or her currency back to the account. Once a buyer chooses a listing by clicking on it, he should send the correct amount into the platform pot 152 within the time allowed. Once the buyer's deposit is cleared to the platform pot 152, the system 100 sends out the exchanged amount into each member's corresponding currency account.

Optionally. the system may require that if either the seller or buyer pulls out without sending the promised amount after having agreed on a listing or offer in a private chat, the party pulling out will lose his or her guarantee amount and the opposite party will get back his or her guarantee amount deposited plus the guarantee amount of the party pulling out.

One example of the method of this second embodiment is as follows. Seller C has 10,000 EUR and wants to change it into USD at the rate of USD:EUR to be 1.21:1 to get 12,100 USD. Seller C does not want to send the whole amount yet, so he or she decides to choose to send enough amount for the right to exchange currency. Seller C is notified by the system 100 that the system 100 had set the guarantee money at 50 USD or 40 EUR for the right to list and deal and the system 100 had set the minimum amount listed to be dealt to be 4,000 EUR or 5,000 USD. A system manager may determine the amount of guarantee money and upper and lower amount limit to be dealt. Seller C sends or deposits 40 EUR from Seller C's EUR account into the EUR account 153 of the platform pot 152. As illustrated in FIG. 5, Seller C lists the following information: “Seller C, has 10,000 EUR, wants USD:EUR=1.21:1, You need 12,100 USD”. Buyer D finds that offer on the listing interesting and sends 50 USD from Buyer D's USD account into the platform's USD account to get the right to be able to click on this listing to accept the offer or make a counteroffer to deal with Seller C. After sending 50 USD into the platform's USD account, the Buyer D clicks on Seller C's deal button opening a private window. Buyer D types a message 474 in the window asking if he could sell only 9,500 EUR since that is the amount he needs and if he could accept the exchange rate of 1.20 instead of 1.21 as shown in FIG. 6. Seller C accepts Buyer D's suggestions or counteroffer and changes the amount and the exchange rate on the listing to 9500 EUR and 1.20 rate, respectively. Seller C can accept the counteroffer by clicking on the accept button 476 and then change the amount and rate. Alternatively, the Seller C can accept the counteroffer by just changing the amount and rate.

After Seller C does this change, the display then shows a message 478 that the Buyer D now needs to deposit 11,350 USD as shown in FIG. 7. This new amount is based on the new amount of EUR (9500) and USD:EUR rate 1:1.2 minus the 50 USD that Buyer D deposited into platform's USD account 155. The new amount is calculated as follows: 9500×1.2-50. This new amount is displayed inside the private window for viewing by both the displays 118 of the client devices 101 of Seller C and Buyer D. Both Seller C and Buyer D click on their respect accept buttons 480 displayed inside the chatting window. Now the allowed time period starts to count down and Seller C deposits 9460 EUR (9500 EUR-40 EUR of the guarantee money) from Seller C's EUR account into the EUR account of the platform pot 152 while the Buyer D deposits 11,350 USD from Buyer D's USD account into the USD account 155 of the platform pot 152. Once both Seller C and Buyer D complete the deposit within the predetermined period of time after the reserve condition is activated, the system 100 sends 11,400 USD to Seller C's US Dollar account 160 and 9500 EUR to Buyer D's Euro account 154.

The present invention provides an online currency exchange that affords immediate transparency, which allows the respective parties to keep tabs on all aspects of the transaction, thereby increasing efficiency, lowering costs, and enhancing security. In addition, flexibility is provided in which the buyers and sellers can negotiate to change the terms of the exchange transaction. Also, there is no commission on currency exchanges between buyers and sellers using the present invention.

Although various embodiments of the disclosed system and method for exchanging currency have been shown and described, modifications may occur to those skilled in the art upon reading the specification. The present application includes such modifications and is limited only by the scope of the claims.

What is claimed is:

1. A computer-implemented method for exchanging currency comprising the following operations performed by at least one processor:
receiving, at an online currency exchange platform, a first request from a first client device of a seller to exchange a first amount of a first type of currency with a second amount of a second type of currency calculated at a currency exchange rate;
communicating the first request to at least a second client device of a buyer;
receiving, at the online currency exchange platform, a response by the second client device to accept the first request from the first client device;
receiving, at the online currency exchange platform, the first amount of the first type of currency from a first account of the first type of currency associated with the first client device;
receiving, at the online currency exchange platform, the second amount of the second type of currency from a second account of the second type of currency associated with the second client device; and
transferring the first amount of the first type of currency to a third account of the first type of currency associated with the second client device and the second amount of the second type of currency to a fourth account of the second type of currency associated with the first client device.

2. The computer-implemented method of claim 1, wherein communicating the first request to at least the second client device is performed in response to receiving, at the online currency exchange platform, the first amount of the first type of currency from the first account associated with the first client device.

3. The computer-implemented method of claim 1, wherein communicating the first request to at least the second client device is performed in response to receiving, at the online currency exchange platform, at least a minimum portion of the first amount of the first type of currency from the first account associated with the first client device.

4. The computer-implemented method of claim 3, further comprising:
subsequent to communicating the first request to at least the second client device, receiving, at the online currency exchange platform, a second request by the second client device to change the first request such that one of or any combination of the first amount is requested to be changed, the second amount is requested to be changed, and the currency exchange rate is requested to be changed;
communicating the second request to the first client device;
receiving, at the online currency exchange platform, a second response by the first client device that changes the first request according to the second request by the second client device; and
wherein receiving, at the online currency exchange platform, the response by the second client device to accept the first request from the first client device includes the one or more changes in the first request.

5. The computer-implemented method of claim 4, wherein communicating the second request to the first client device is performed subsequent to receiving, at the online currency exchange platform, at least a minimum portion of the second amount of the second type of currency from the second account associated with the second client device.

6. The computer-implemented method of claim 5, wherein communicating the first request to at least the second client device further includes communicating the first request to at least a third client device of another buyer, wherein the method further comprises activating a buyer disabler module to prevent the online currency exchange platform from receiving a response by the third client device to accept the first request from the first client device after receiving, at the online currency exchange platform, the response by the second client device to accept the first request from the first client device.

7. The computer-implemented method of claim 6, further comprising deactivating the buyer disabler module to enable the online currency exchange platform to receive a response by the at least third client device to accept the first request from the first client device if the second amount of the second type of currency from the second account associated with the second client device is not received at the online currency platform within a predetermined time after receiving, at the online currency exchange platform, the response by the second client device to accept the first request from the first client device.

8. The computer-implemented method of claim 5, further comprising activating an exchange rate blocker to prevent changing the exchange rate by the first client after receiving, at the online currency exchange platform, the response by the second client device to accept the first request from the first client device.

9. The computer-implemented method of claim 5, further comprising activating a seller disabler module to prevent the removal of the first request from the online currency exchange platform by the first client device after receiving, at the online currency exchange platform, the response by the second client device to accept the first request from the first client device.

10. The computer-implemented method of claim 1, wherein communicating the first request to at least the second client further includes communicating the first request to at least a third client device of another buyer, wherein the method further comprises activating a buyer disabler module to prevent the online currency exchange platform from receiving a response by the third client device to accept the first request from the first client device after receiving, at the online currency exchange platform, the response by the second client device to accept the first request from the first client device.

11. The computer-implemented method of claim 10, further comprising deactivating the buyer disabler module to enable the online currency exchange platform to receive a response by the at least third client device to accept the first request from the first client device if the second amount of the second type of currency from the second account associated with the second client device is not received at the online currency platform within a predetermined time after receiving, at the online currency exchange platform, the response by the second client device to accept the first request from the first client device.

12. The computer-implemented method of claim 1, further comprising activating an exchange rate blocker to prevent changing the exchange rate by the first client after receiving, at the online currency exchange platform, the response by the second client device to accept the first request from the first client device.

13. The computer-implemented method of claim 1, further comprising activating a seller disabler module to prevent the removal of the first request from the online currency exchange platform by the first client device after receiving, at the online currency exchange platform, the response by the second client device to accept the first request from the first client device.

14. The computer-implemented method of claim 1, wherein communicating the first request to at least the second client further includes communicating the first request to at least a third client device of a buyer, wherein the method further comprises:
activating a buyer disabler module to prevent the online currency exchange platform from receiving a response by the third client device to accept the first request from the first client device after receiving, at the online currency exchange platform, the response by the second client device to accept the first request from the first client device;
activating an exchange rate blocker to prevent changing the exchange rate by the first client after receiving, at the online currency exchange platform, the response by the second client device to accept the first request from the first client device; and
activating a seller disabler module to prevent the removal of the first request from the online currency exchange platform by the first client device after receiving, at the online currency exchange platform, the response by the second client device to accept the first request from the first client device.

15. A non-transitory computer-readable storage medium storing executable instructions that, as a result of being executed by one or more processors of a computer system, cause the computer system to at least:
receive, at an online currency exchange platform, a first request from a first client device of a seller to exchange a first amount of a first type of currency with a second amount of a second type of currency calculated at a currency exchange rate;
communicate the first request to at least a second client device of a buyer;
receive, at the online currency exchange platform, a response by the second client device to accept the first request from the first client device;
receive, at the online currency exchange platform, the first amount of the first type of currency from a first account of the first type of currency associated with the first client device;
receive, at the online currency exchange platform, the second amount of the second type of currency from a second account of the second type of currency associated with the second client device; and
transfer the first amount of the first type of currency to a third account of the first type of currency associated with the second client device and the second amount of the second type of currency to a fourth account of the second type of currency associated with the first client device.

16. The non-transitory computer-readable storage medium of claim 15, wherein communicating the first request to at least the second client device is performed in response to receiving, at the online currency exchange platform, the first amount of the first type of currency from the first account associated with the first client device.

17. The non-transitory computer-readable storage medium of claim 15, wherein communicating the first request to at least the second client device is performed in response to receiving, at the online currency exchange platform, at least a minimum portion of the first amount of the first type of currency from the first account associated with the first client.

18. The non-transitory computer-readable storage medium of claim 17, wherein the instructions further including instructions that, as a result of being executed by one or more processors, cause the computer system to:
subsequent to communicating the first request to at least the second client device, receive, at the online currency exchange platform, a second request by the second client device to change the first request such that one of or any combination of the first amount is requested to be changed, the second amount is requested to be changed, and the currency exchange rate is requested to be changed;
communicate the second request to the first client device subsequent to receiving, at the online currency exchange platform, at least a minimum portion of the second amount of the second type of currency from the second account associated with the second client;
receive, at the online currency exchange platform, a second response by the first client device that changes the first request according to the second request by the second client device; and
wherein receiving, at the online currency exchange platform, the response by the second client device to accept the first request from the first client device includes the one or more changes in the first request.

19. The non-transitory computer-readable storage medium of claim 15, wherein communicating the first request to at least the second client further includes communicating the first request to at least a third client device of another buyer, wherein the instructions further including instructions that, as a result of being executed by one or more processors, cause the computer system to:
activate a buyer disabler module to prevent the online currency exchange platform from receiving a response by the third client device to accept the first request from the first client device after receiving, at the online currency exchange platform, the response by the second client device to accept the first request from the first client device;
activate an exchange rate blocker to prevent changing the exchange rate by the first client after receiving, at the online currency exchange platform, the response by the second client device to accept the first request from the first client device; and
activate a seller disabler module to prevent the removal of the first request from the online currency exchange platform by the first client device after receiving, at the online currency exchange platform, the response by the second client device to accept the first request from the first client device.

20. The non-transitory computer-readable storage medium of claim computer-implemented method of claim 19, wherein the instructions further including instructions that, as a result of being executed by one or more processors, cause the computer system to:
deactivate the buyer disabler module to enable the online currency exchange platform to receive a response by at least the third client device to accept the first request from the first client device if the second amount of the second type of currency from the second account associated with the second client device is not received at the online currency platform within a predetermined time after receiving, at the online currency exchange platform, the response by the second client device to accept the first request from the first client device;
deactivate the exchange rate blocker to enable changing the exchange rate by the first client if the second amount of the second type of currency from the second account associated with the second client device is not received at the online currency platform within the predetermined time after receiving, at the online currency exchange platform, the response by the second client device to accept the first request from the first client device; and
deactivate a seller disabler module to enable the removal of the first request from the online currency exchange platform by the first client device if the second amount of the second type of currency from the second account associated with the second client device is not received at the online currency platform within the predetermined time after receiving, at the online currency exchange platform, the response by the second client device to accept the first request from the first client device.
